(19) United States
(12) Patent Application Publication
(10) Pub. No.: US 2017/0047675 A1
(43) Pub. Date: Feb. 16, 2017

(54) ELECTRICAL CONNECTOR USED FOR MODULAR MOBILE DEVICE

(71) Applicant: FOXCONN INTERCONNECT TECHNOLOGY LIMITED, Grand Cayman (KY)

(72) Inventors: MING-QI GE, Kunshan (CN); LI-DONG TANG, Kunshan (CN); JIAN-HUA LIANG, Kunshan (CN); XIAN-DONG BAO, Kunshan (CN)

(21) Appl. No.: 15/235,100

(22) Filed: Aug. 11, 2016

(30) Foreign Application Priority Data
Aug. 12, 2015 (CN) 201510491950.3

(51) Int. Cl. H01R 12/71; H04M 1/02; H01R 4/02; H01F 5/00; H01R 13/66

(52) U.S. Cl. CPC H01R 12/716; H01F 5/00; H01R 13/665; H01R 4/02; H04M 1/0274; H04M 1/0249; H01R 2107/00

(57) ABSTRACT

An electrical connector is applied on a module mobile device with a frame and includes a magnetic element and a plurality of conductive terminals assembled into the magnetic element. Each conductive terminal defines a contacting portion exposed upwardly outside of the magnetic element and a soldering portion extending downwardly outside of the magnetic element.

### BACKGROUND OF THE INVENTION

1. Field of the Invention

The present invention relates to an electrical connector, and more particularly to an electrical connector applied on a modular mobile device to transmit signals.

2. Description of the Related Art

A modular phone includes a frame (Endo), which is basically a motherboard without screen, battery or any other smartphone components. Users need to purchase additional modules separately and then assemble them into the frame, so as to create a complete mobile phone. It makes the mobile phone upgrades easier in the future, and also let users can customize mobile phone according to their demand. Each frame is divided into two sides: the front side of the frame defines basically a huge slot reserved for the display, and also may have a front camera or speaker interface required. In the back side of the phone, you'll see horizontal and vertical dividing lines, which are referred to as the “spine” and “rib” that they would divide the back side into 1×1, 1×2 or 2×2 grids for placing different modules. The modules of the phone will be fixed into the grids by Electro Permanent Magnet (EPM). The EPM is a mixture of electromagnets and ordinary permanent magnets, which can be turned on or off by an electric current. When the EPM is turned on, it will remain in this state and no longer requires an electric current through. Notably, the EPM means is the traditional method while the electrical connector equipped/cooperating with the EPM means to activate electrical connection between a counterpart element and the system when such a counterpart element is securely positioned on the system via the EPM means, is required to be further improved.

Signal transmission between the modules and the frame of the modular phone is usually accomplished by probe (Pogo Pin) connector. The probe connector is a spring probe having sophisticated spring construction. Taiwan Patent No. M466396 issued on Nov. 21, 2013, discloses an electrical connector used for abutting on a circuit board and magnetically attracted a mating connector. The electrical connector includes an insulative housing with a plurality of terminal slots, a plurality of terminals received in the terminal slots and at least one magnetic element disposed in the insulative housing, wherein at least one terminal includes a contacting terminal and an elastic contacting member. The elastic contacting member defines a contacting portion used for mating the contacting terminal and an abutting portion exposed outside of the terminal slot, the abutting portion is used for pressing against the circuit board. Because of the magnetic element disposed on the side of the terminal, the electrical connector should occupy a larger space, which is not conducive to miniaturization of the electrical connector.

Therefore, an improved electrical connector is highly desired to meet overcome the requirement.

### BRIEF SUMMARY OF THE INVENTION

An object of the present invention is to provide an electrical connector optimizing the layout of the modular mobile device.

In order to achieve above-mentioned object, an electrical connector is applied on a module mobile device with a frame and includes a magnetic element and a plurality of conductive terminals assembled into the magnetic element. Each conductive terminal defines a contacting portion exposed upwardly outside of the magnetic element and a soldering portion extending downwardly outside of the magnetic element.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view showing an electrical connector in accordance with the present invention;

FIG. 2 is another perspective view of the electrical connector shown in FIG. 1;

FIG. 3 is an exploded perspective view of the electrical connector shown in FIG. 1;

FIG. 4 is an exploded perspective view of the electrical connector shown in FIG. 2; and

FIG. 5 is a cross-sectional view of the electrical connector taken along the line 5-5 shown in FIG. 1.

### DESCRIPTION OF PREFERRED EMBODIMENT OF THE INVENTION

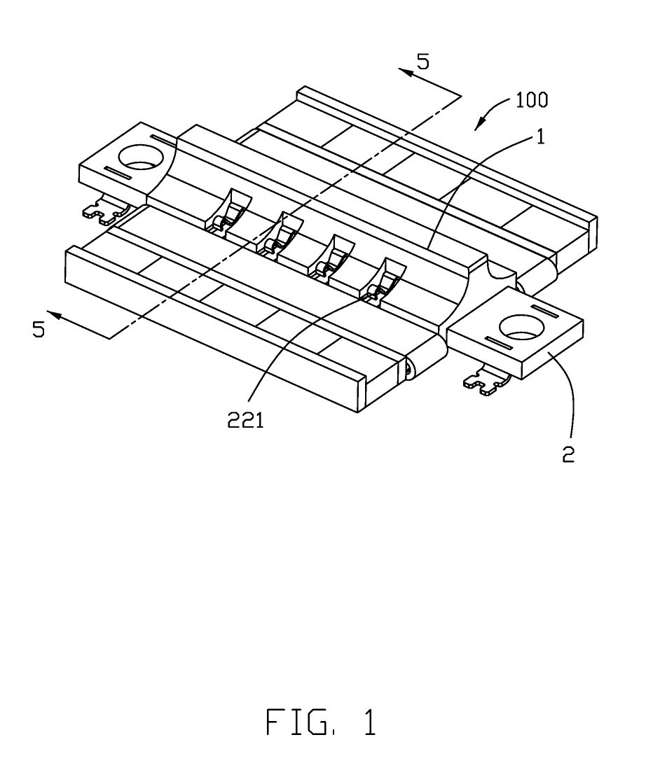

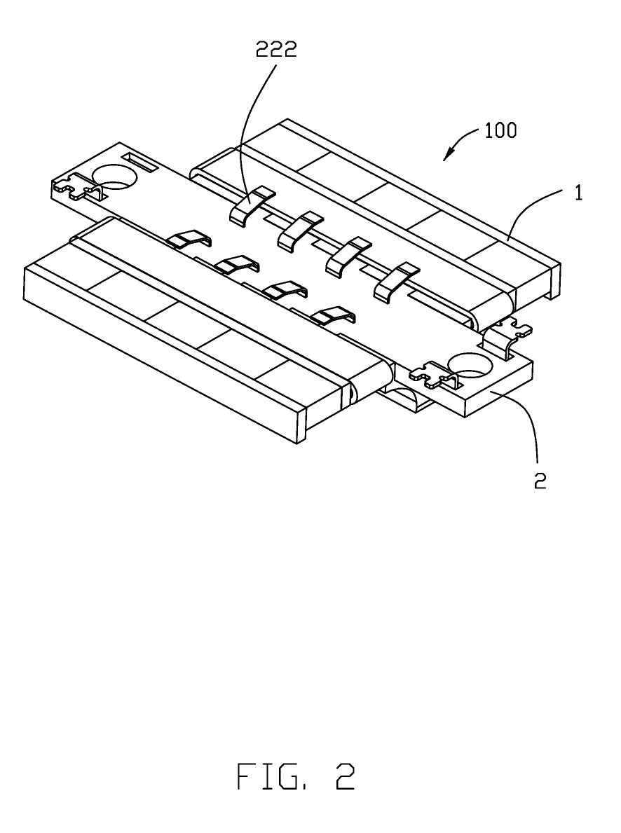

Reference will now be made to the drawing figures to describe a preferred embodiment of the present invention in detail. Referring to FIG. 1 to FIG. 2, an electrical connector 100 is used in a modular mobile device (not shown), such as a modular phone. The modular mobile device includes a frame with a printed circuit board and a plurality of modules detachably mounted to the frame, the electrical connector 100 is used for transmitting signals between the modules and the frame. The frame includes a plurality of horizontal and vertical segmented ribs, the segmented ribs divide the frame into a number of different sizes receiving cavities for the various modules. The modules have different sizes and each defines a module body and at least one gold fingers exposed to the outside of the module body.

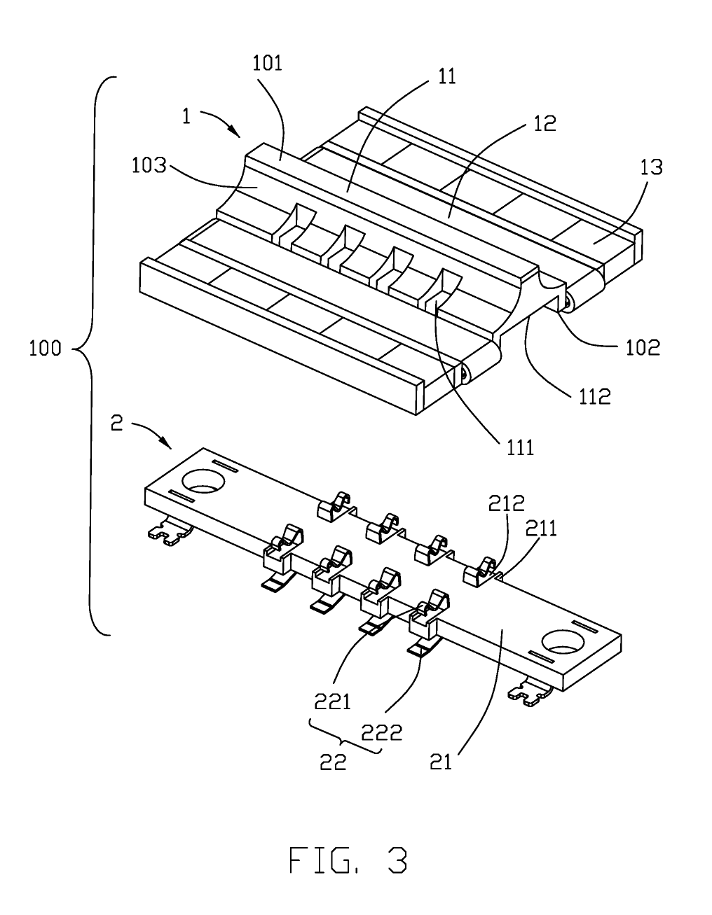

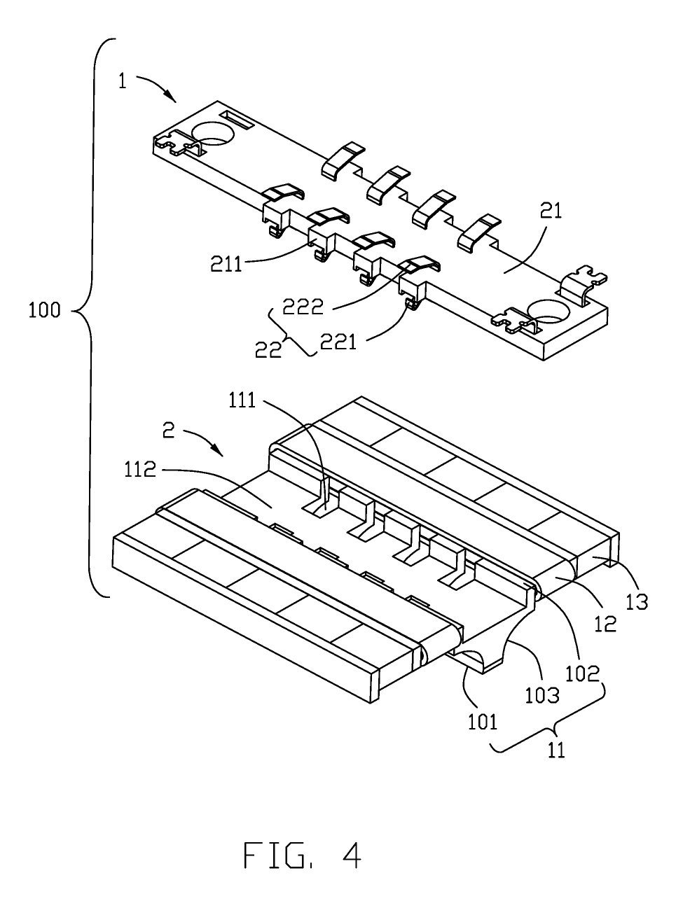

Referring to FIG. 3 to FIG. 4, the electrical connector 100 includes a magnetic element 1 and a terminal module 2 assembled into the magnetic element 1. The magnetic element (subassembly) 1 includes a central hard magnet 11 extending along a longitudinal direction, a pair of coils 12 located in the both sides of the hard magnet 11 in a transverse direction perpendicular to the longitudinal direction and a pair of soft magnets 13 disposed outside of the coils 12 and adsorbed to the hard magnet 11, the coils 12 surround the hard magnet 11 in the longitudinal direction. The hard magnet 11 defines a first portion 101 with a first width, a second portion 102 with a second width and a shoulder 103 connecting the first portion 101 and the second portion 102, the second width is greater than the first width. The shoulder 103 defines a plurality of terminal slots 111, the second portion 102 defines a receiving slot 112, and the receiving slot 112 is located below the terminal slots 111 and communicating with the terminal slots 111.

The terminal module 2 is assembled into the receiving slot 110 from one side of the second portion 102 and includes an insulative housing 21 and a plurality of conductive terminals 22 retained in the insulative housing 21. Each conductive terminal 22 includes a contacting portion 221 received in the terminal slot 111 and exposed outside of the shoulder 103, a soldering/connecting portion 222 extending outside of the second portion 102, and a retaining portion 220 located between the contacting portion 221 and the soldering portion 222 and connecting with the contacting portion 221 and the soldering portion 222 in a vertical direction perpendicular to the transverse portion and the longitudinal direction. The contact portion 221 is curved shaped and elastically deformable along an extending direction of the shoulder 103 when the module is assembled into the frame. The insulative housing 21 defines a set of supporting portions 211 protruding outside therefrom, and the supporting portions 211 are corresponding to both the contacting portions 221 and the terminal slots 111 respectively, each supporting portion 211 defines a cavity 212 facing the respective terminal slot 111 to accommodate an deformation of the respective contacting portion 221.

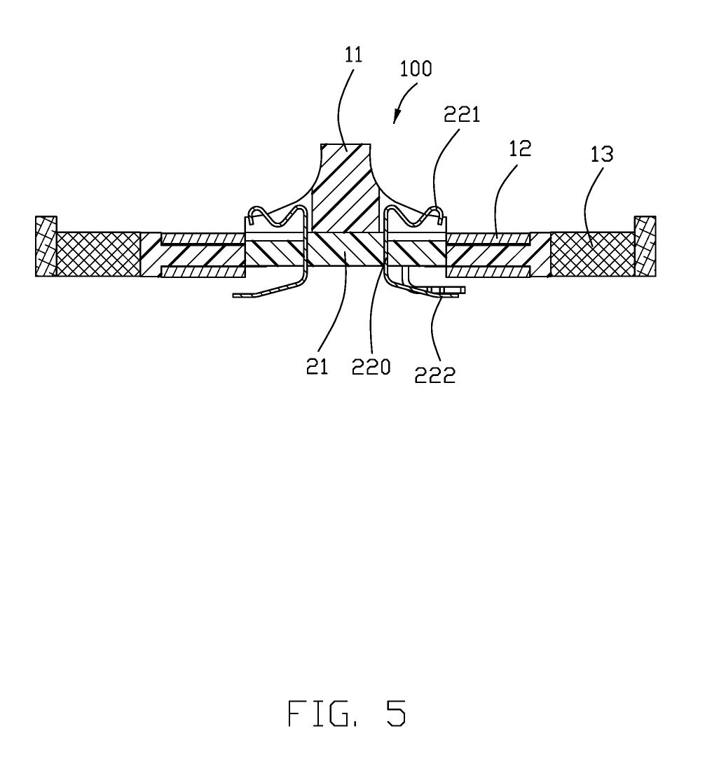

Referring to FIG. 5, the terminal module 2 is assembled into the receiving slot 112 along a width direction of the frame. When the gold fingers contact with the contacting portions 221, the gold fingers are pressed against the conductive terminals 22, and the conductive terminals 22 are elastic deformation along the extending direction of the shoulder 103, which ensure close contact between the gold fingers and the conductive terminals 22. Thus, the electrical connector 100 is electrically connected to the modules for transmitting electrical signals. In a preferred embodiment, the terminal slots 111 are divided into two rows and the conductive terminals 22 are also divided into two rows to be fixed into the corresponding terminal slots 111. Accordingly, the electrical connector 100 may provide electrical connection between two modules.

The terminal module 2 of the electrical connector 100 is directly assembled into the magnetic element 1, which saving space of the side of the magnetic element 1 and optimizing the layout of the modular mobile device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector, applied on a module mobile device with a frame and comprising:
a magnetic element; and
a plurality of conductive terminals assembled into the magnetic element, each conductive terminal defines a contacting portion exposed upwardly outside of the magnetic element and a soldering portion extending downwardly outside of the magnetic element.

2. The electrical connector as described in claim 1, wherein the module mobile device includes a printed circuit board and a plurality of modules detachably mounted to the frame, the contacting portions are used for pressing against the modules and the soldering portions are welded on the printed circuit board.

3. The electrical connector as described in claim 2, wherein the contact portion is curved shaped and elastically deformable when the module is assembled into the frame.

4. The electrical connector as described in claim 1, wherein the magnetic element includes a central hard magnet extending along a longitudinal direction, the hard magnet defines a first portion with a first width, a second portion with a second width and a shoulder connecting the first and second portions, the second width is greater than the first width, the shoulder defines a plurality of terminal slots and the contacting portion are retained in the terminal slots and exposed outside of the shoulder.

5. The electrical connector as described in claim 4, wherein the conductive terminal includes a retaining portion located between the contacting portion and the soldering portion and connecting with the contacting portion and the soldering portion along a vertical direction perpendicular to the longitudinal direction.

6. The electrical connector as described in claim 4, wherein the electrical connector includes an insulative housing for retaining the conductive terminals, the second portion of the hard magnet defines a receiving slot used for receiving the insulative housing, and the receiving slot of the second portion is located below the terminal slots and communicating with the terminal slots.

7. The electrical connector as described in claim 6, wherein the insulative housing defines a set of supporting portions protruding outside therefrom, and the supporting portions are corresponding to both the contacting portions and the terminal slots respectively, each supporting portion defines a cavity facing the respective terminal slot to accommodate an deformation of the respective contacting portion.

8. The electrical connector as described in claim 4, wherein the magnetic element includes a pair of coils located in the both sides of the hard magnet in a transverse portion perpendicular to the longitudinal direction and a pair of soft magnets disposed outside of the coils and adsorbed to the hard magnet, the coils surround the hard magnet in the longitudinal direction.

9. The electrical connector as described in claim 4, wherein the terminal slots are divided into two rows and the conductive terminals are also divided into two rows to be fixed into the corresponding terminal slots.

10. A module mobile device, comprising:
a frame equipped with a printed circuit board;
a plurality of modules detachably mounted to the frame; and
at least one electrical connector used for transmitting signals between the modules and the frame, and the electrical connector including a magnetic element and a terminal module assembled into the magnetic element; wherein
the terminal module includes an insulative housing and a plurality of conductive terminals retained in the insulative housing, the magnetic element has a receiving slot with the insulative housing accommodated therein and a set of receiving slots passing therethrough and communicating with the receiving slot, each conductive terminal defines a contacting portion received in the terminal slot, and a soldering portion opposite to the contacting portion and extending outside of the insulative housing, the contacting portions are pressing against the modules and the soldering portions are welded on the printed circuit board.

11. The module mobile device as described in claim 10, wherein the frame includes a plurality of horizontal and vertical segmented ribs, the segmented ribs divide the frame into a number of different sizes receiving cavities for the modules, the modules have different sizes and each defines a module body and at least one gold fingers exposed to the outside of the module body.

12. The module mobile device as described in claim 11, wherein when the gold fingers contact with the contacting portions, the gold fingers are pressed against the conductive terminals, and the conductive terminals are elastic deformation.

13. The module mobile device as described in claim 10, wherein the insulative housing defines a set of supporting portions protruding outside therefrom, and the supporting portions are corresponding to both the contacting portions and the terminal slots respectively.

14. The module mobile device as described in claim 13, wherein each supporting portion defines a cavity facing the respective terminal slot to accommodate an deformation of the respective contacting portion.

15. An electrical connector assembly comprising:
a magnetic element subassembly forming a receiving slot and a plurality of terminal slots spaced from one another along a longitudinal direction and commonly communicating with said receiving slot;
a terminal module including a plurality of conductive terminals integrally formed with an insulative housing; wherein
each of said terminals includes an elastic contacting portion extending through the corresponding terminal slot and upwardly exposed to an exterior above the magnetic element, and a connecting portion opposite to said contacting portion in a vertical direction perpendicular to said longitudinal direction for mounting to a printed circuit board.

16. The electrical connector assembly as claimed in claim 15, wherein the magnetic element subassembly forms an upward concave surface where the terminal slots are terminated and through which the contacting portions of said terminals extend upwardly.

17. The electrical connector assembly as claimed in claim 15, wherein said magnetic element subassembly includes a center magnet and a pair of side magnets by two sides of the center magnet in a transverse direction perpendicular to both said longitudinal direction and said vertical direction, and said terminal module is located under said center magnet.

18. The electrical connector assembly as claimed in claim 17, wherein said center magnet is a hard magnet while the side magnets are soft magnets.

19. The electrical connector assembly as claimed in claim 18, wherein a coil is located between each of said soft magnets and said hard magnet in said transverse direction.

20. The electrical connector assembly as claimed in claim 19, wherein said magnetic element subassembly includes at least one insulative portion on which said coil is positioned.
